(19) United States
(12) Patent Application Publication
(10) Pub. No.: US 2002/0166875 A1
(43) Pub. Date: Nov. 14, 2002

(54) Dispenser for medical creams

(76) Inventor: Daniel O. Sokoloff, Palm Beach Gardens, FL (US)

Correspondence Address: J. Rodman Steele, Jr., Akerman, Senterfitt & Eidson, P.A., P.O. Box 3188, West Palm Beach, FL, 33402-3188, US

(21) Appl. No.: 10/132,595

(22) Filed: Apr. 25, 2002

Related U.S. Application Data
(60) Provisional application No. 60/286,811, filed on Apr. 26, 2001.

(51) Int. Cl. B67D 5/06

(52) U.S. Cl. 222/192

(57) ABSTRACT

The present invention concerns a topical treatment dispenser including a sanitary housing having at least one outlet for receiving and supporting a tube containing a topical treatment, a sanitary detachable cap for covering the outlet and a flow control mechanism for controlling the flow of the topical treatment through the outlet. The topical treatment dispenser prevents contaminants from coming into contact with the topical treatment contained therein such that the topical treatment is dispensable in a medical environment.

### CROSS REFERENCE TO RELATED APPLICATIONS

This is a non-provisional application of provisional application Serial No. 60/286,811 filed on Apr. 26, 2001.

### STATEMENT REGARDING FEDERALLY SPONSORED RESEARCH OR DEVELOPMENT

(Not Applicable)

### BACKGROUND

1. Technical Field

The invention is directed to devices that dispense topical treatments and more particularly devices that dispense topical treatments in a sanitary environment.

2. Description of Related Art

Dermatologists and other health care professionals are frequently called upon to provide topical treatments to the skin or to skin conditions such as lacerations, bums, hematoma, fungi, and other skin conditions similarly treatable. Some of the most common topical treatments include medications dispensed from tubes, such as neosporin, hydrocortisone, and the like. Typically, such treatments are packaged in a tube, and are applied by distributing the medication upon a gauze bandage, and the bandage is then applied directly to the affected area. During the course of a typical day, a tube of topical cream or ointment may be used many times by doctors, nurses, and other medical personnel.

One difficulty with applying such treatments to a variety of patients is that, with each use, the tubes become messy or sticky with the constant removal and rescrewing of tube caps, and that excess cream frequently escapes the tube but does not end up on the bandage, but on the outside of the tube near the nozzle. Such excess cream not only makes the tubes slippery and difficult to handle, but also contributes to an unsanitary condition in which bacteria and dirt may accumulate on the outside of the tube and possibly contaminate gloves or gauze bandages that my come into contact with a patient's affected skin. Such conditions are not tolerable in offices of health care providers. However, the alternative is to hold each person who applies creams responsible for cleaning the tube, wiping off any excess cream, and carefully replacing the tube cap after applying each treatment. These procedures are time-consuming, and, during the course of a busy day of treating patients, are among the most likely to be omitted by doctors and nurses. What is needed is an cream dispenser that will permit the proper amount of cream to be dispensed directly to a bandage or applicator with a simple motion of the hand or foot without having excess cream remain on the outside of the dispenser, and that will maintain the cream remaining in the dispenser in a sanitary condition and available for a next application.

### SUMMARY OF THE INVENTION

A wall-mounted dispenser holds a medication cream so that the cream may be dispensed vertically downward simply by pressing a small lever or panel on the dispenser. One embodiment is suitable for holding tubes of medication, while a second embodiment will dispense the medication in bulk from a sanitary high density polyethylene plastic bag or other suitable packaging.

The tube dispenser holds the tube vertically, with the tube nozzle facing downward. A non-threaded removable cap can be spring loaded or otherwise biased between a first position of pressing against the tube opening, to hold the contents in and to prevent air or contaminants from coming into contact with the cream, and a second position of being rotated away from the tube opening so that the contents of the tube may be expressed onto a gauze pad or applicator. If desired, the cap can be configured to hold a felt pad imbued with alcohol or some other antiseptic to maintain a sterile environment around the tube opening.

A tube of cream is held nozzle-downward within an upright, receptacle attached to a wall-mounted plate. The receptacle may have a rectangular cross-section whose dimensions are slightly larger than the tube such that the tube will be maintained in a substantially vertical position. A semi-rigid plastic film may be attached to a lower portion of the receptacle, extending upward to a height slightly above the length of the tube of cream. When the tube has been inserted into the receptacle, and the plastic film placed against it, a roller or other sliding object having a curved surface is placed in the receptacle and allowed to press the plastic film against the uppermost portion of the tube. The plastic film provides a smooth surface for the roller to press against, and prevents the tube from buckling or creasing when pressed by the roller. When cream is to be dispensed, the roller or sliding object is pressed downward, causing the tube to flatten at its upper end and expressing cream through the lower tube opening. Various mechanical arrangements may be used to urge the roller or sliding object downward against the tube, as are depicted in the drawings described below.

An alternative embodiment of the tube dispenser may be used in which the downward force is applied through a hydraulic or pneumatic bladder that is inserted in the receptacle in place of a roller or other sliding object. In either case, pressure is placed upon the tube when the bladder is inflated. The pump or other mechanism for providing air or water under pressure can also be wall-mounted along with or nearby the cream dispensing unit, and may be activated by hand pressure or, if desired, using a small electric motor to deliver the fluid under pressure.

An alternative embodiment of this invention is a dispenser for dispensing medication from a bulk container such as high density polyethylene. The dispenser of this embodiment may be cylindrical in cross section, and will dispense the medication downwardly from the external nozzle at the lower extremity of the dispenser. In one embodiment, the medication flows into a flexible, cylindrical dispensing tube where it may thereafter be dispensed by mechanical squeezing of the dispensing tube. If desired, a one-way flap valve may be used to prevent the medication from being forced back into the bulk chamber. In a second embodiment, a valve is used to open or close a passageway for the medication, and is activated by a hand lever. When the valve is open, medication may flow through the passageway to the nozzle, where it is released and may fall upon a gauze pad or applicator. Flow of the medication may be gravity induced, or may require the application of external pressure upon the bulk container, depending upon the viscosity of the substance. While medications normally packaged in tubes may be too viscous to flow solely as a result of gravity, manufacturers of the medications may be able to provide them in less-viscous form for bulk packaging as would be suitable for this invention. Where external pressure is needed to promote the flow of the substance, it could take any one of a number of forms, including a simple weight being applied from the top of the dispenser, a spring mechanism, an inflating bladder, or a mechanical downward force being applied as the dispenser is actuated.

### BRIEF DESCRIPTION OF THE DRAWINGS

FIG. 1 depicts a side sectional view of an embodiment of this invention in which a medication packaged in a tube (not shown) is to be dispensed.

FIG. 2 depicts a side sectional view of the invention shown in FIG. 1 in which the dispensing lever has been depressed.

FIG. 3 depicts an alternative embodiment of the dispenser of this invention in side sectional view.

FIG. 4 depicts the dispenser of FIG. 3 in side sectional view with the dispensing mechanism moved to a position in which more leverage is provided.

FIG. 5 depicts another alternative embodiment for dispensing from a tube (not shown) in side sectional view with the pressure mechanism being a hydraulic or pneumatic bladder.

FIG. 6 depicts an alternative embodiment for bulk-packaged medication in side sectional view.

FIG. 7 shows the dispensing mechanism of the embodiment of FIG. 6 in greater detail.

FIG. 8 illustrates the dispensing mechanism of FIG. 6 when the dispensing lever has been pressed.

FIG. 9 depicts an alternative embodiment for bulk-packaged medication in which a valve is used to control the flow of medication from the dispenser.

FIG. 10 represents the valve of FIG. 9 shown in greater detail.

### DESCRIPTION OF THE PREFERRED EMBODIMENTS

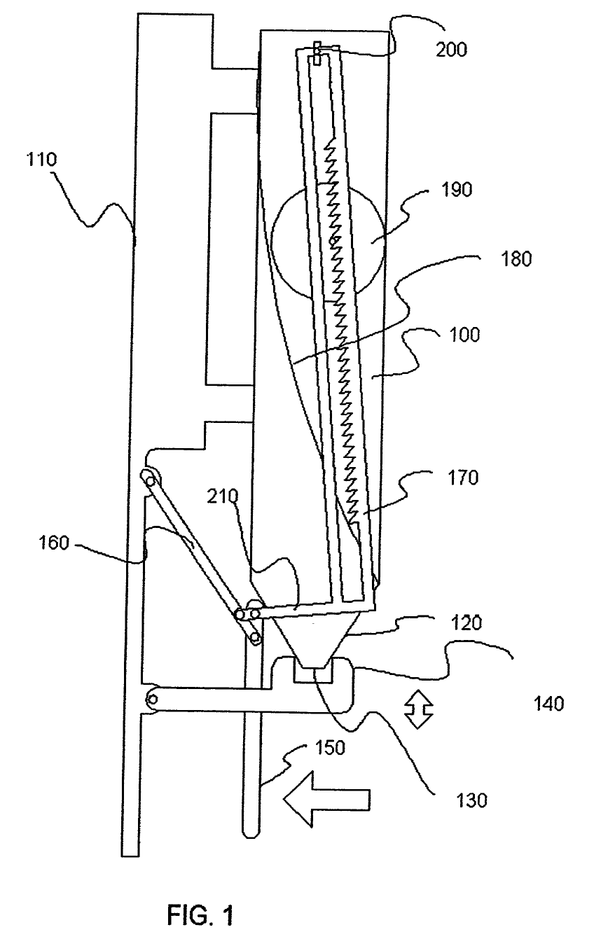

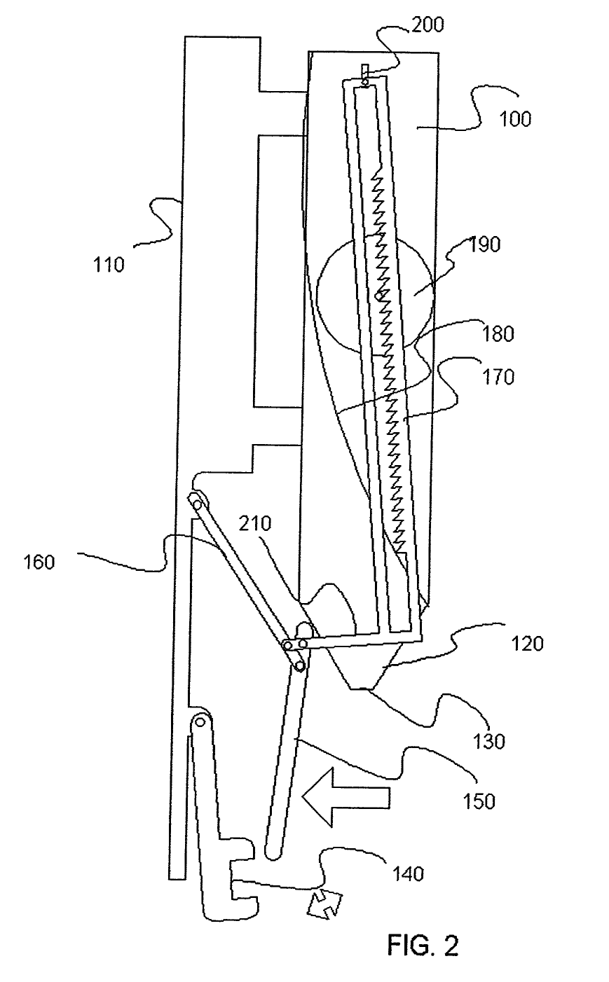

In FIG. 1, a receptacle 100 is attached to a wall mounting 110. The lower extremity 120 of the receptacle 100 is tapered to receive the tapered end of a tube of cream (not shown), with the nozzle of the tube, which is normally threaded, extending through opening 130. Because this invention is designed to dispense creams as they are currently packaged, there may be at least some degree of imprecision in the fit of the tube into the receptacle. Thus, if desired, the receptacle may use a threaded opening at 130 to secure the tube to the bottom of the receptacle and to ensure that removable cap 140 can achieve a tight fit with the tube nozzle. A spring or other biasing mechanism (not shown) may be used to hold cap 140 tight against the tube nozzle when cream is not being dispensed, or fully away from the tube nozzle when cream is dispensed, as depicted in FIG. 2.

A mechanical pressure pad or lever 150 may be depressed in the direction of the arrow to cause cream to be dispensed. When pressed, lever 150 produces a clockwise rotational moment against lever 160, which is rotatably attached to mounting plate 110, causing levers 150 and 160 to move slightly downwardly. A third lever 210 is attached to levers 150 and 160, and to toothed ratchet 170 such that, when levers 150 and 160 move slightly downwardly, toothed ratchet 170 is also forced to move slightly downwardly. Roller 190 has an axle that meshes with the teeth of toothed ratchet 170 when the toothed ratchet is forced downward, causing roller 190 to press downwardly against plastic film 180 and against the tube (not shown) that is immediately beneath the plastic film. The pressure of the roller causes the tube to be compressed, such that cream is expressed from the nozzle of the tube. Toothed ratchet 170 is supported at its upper end by a small pin extending through a slot 200 in the upper portion of receptacle 100.

FIG. 2 depicts the cream dispensing receptacle of FIG. 1 with lever 150 depressed. The depression of lever 150 causes toothed ratchet 170 to move slightly downwardly, pressing roller 190 against plastic film 180 and the tube of cream. When lever 150 is released, toothed ratchet 170 is returned to its original position. However, because its teeth are configured to engage roller 190 only when moving downward, and to slip by the axle of roller 190 when toothed ratchet 170 moves upwardly, the result is to cause roller 190 to re-engage toothed ratchet 170 a few teeth closer to the tube nozzle where, upon a subsequent depression of lever 150, roller 190 will be pressed against the tube at a slightly lower position on the tube.

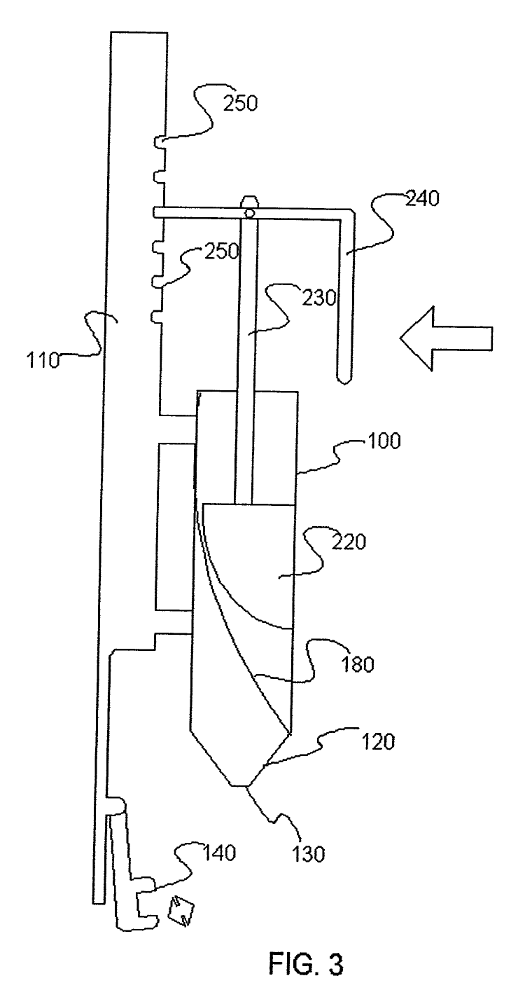

An alternative embodiment of this invention is depicted in FIG. 3, in which the roller has been replaced by sliding object 220. A piston 230 is rotatably attached to lever 240 such that, when lever 240 engages one of a number of niches 250, pressure in the direction of the arrow will cause sliding object 220 to press downward against plastic film 180 and cause cream to be expressed from the tube (not shown).

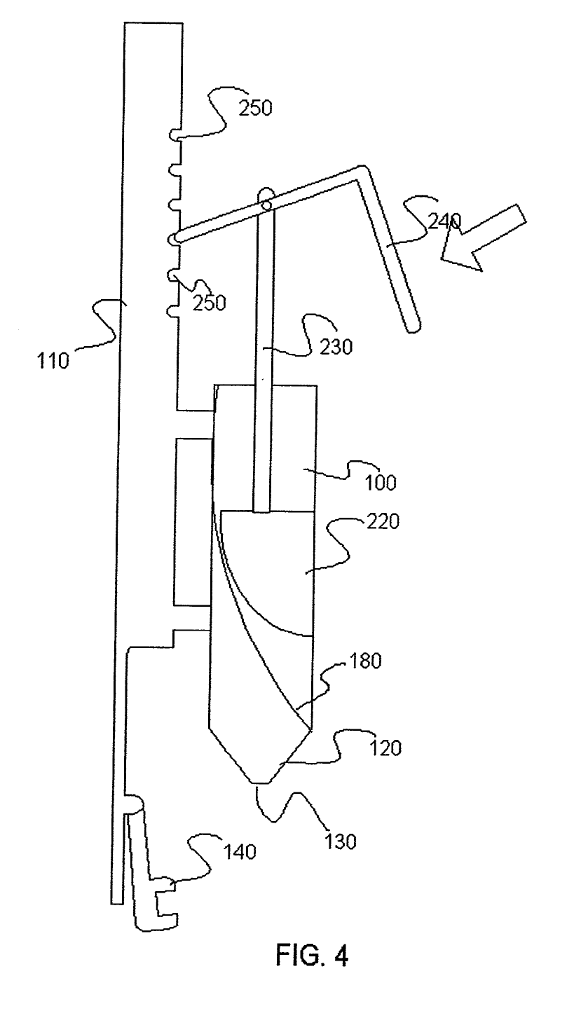

In FIG. 4, lever 240 has been moved to a different niche 250 to compensate for the fact that sliding object 220 and piston 230 have moved lower in the receptacle as cream has been expressed from the tube. Pressure may once again be applied to sliding member 220 when lever 240 is pressed downwardly, causing additional cream to be dispensed.

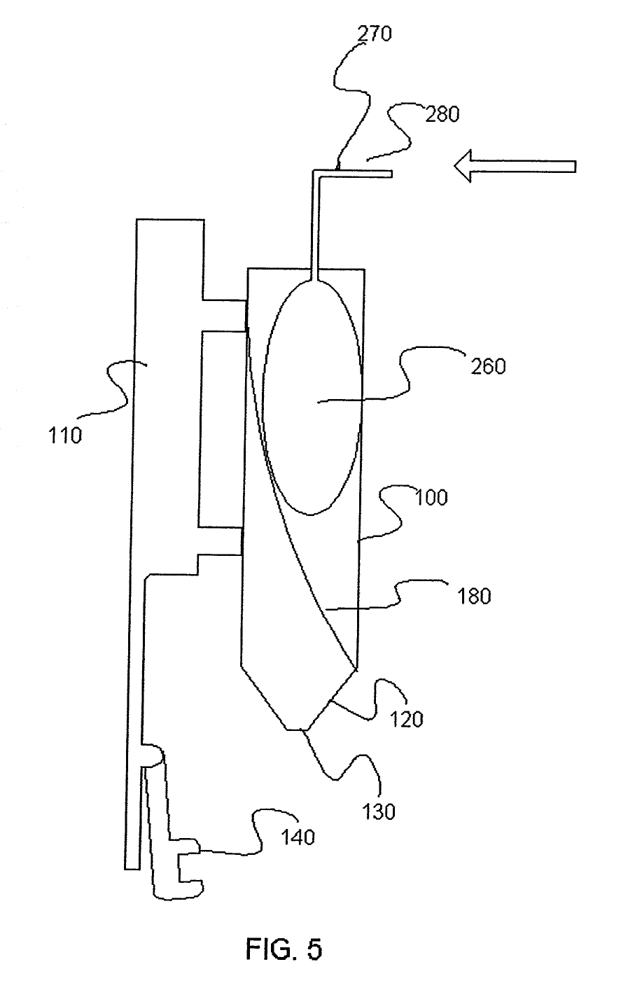

The embodiments shown in FIGS. 1-4 have the advantage of being simple, mechanical dispensers in which the amount of cream dispensed may be regulated simply by exerting greater or lesser pressure or movement of the operating levers. FIG. 5 depicts an embodiment in which a bladder 260 may be inflated with a suitable fluid, such as air or water, to cause the bladder to exert pressure against the plastic film 180 and the tube of cream (not shown). The bladder may be expandable or, if desired, may be of a non-expandable material having a constant surface area. If a non-expandable bladder is used, it may be more precisely positioned or anchored within receptacle 100 to ensure that proper pressure is exerted against plastic film 180 and the tube of cream. The bladder is filled and emptied through pneumatic or hydraulic tube 280. A check valve 270 may be used to ensure that the inflating fluid does not escape back into the fluid reservoir (not shown), thereby maintaining a constant pressure upon the tube during times when cream is not being dispensed.

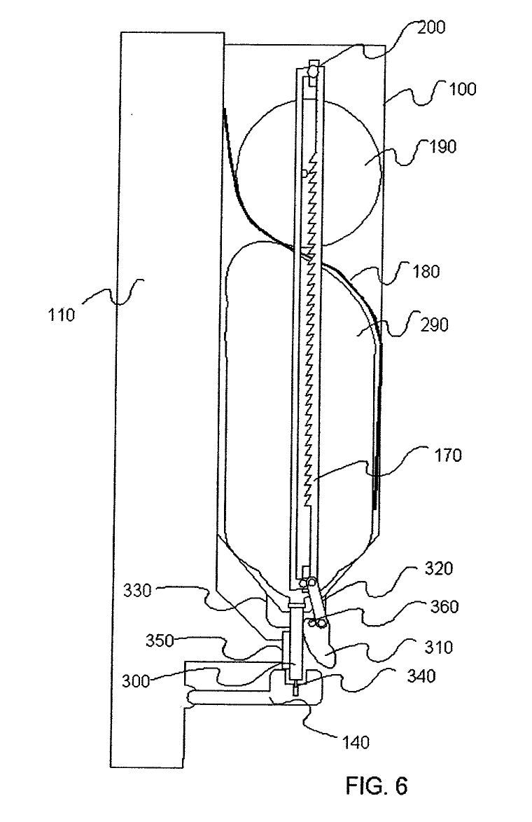

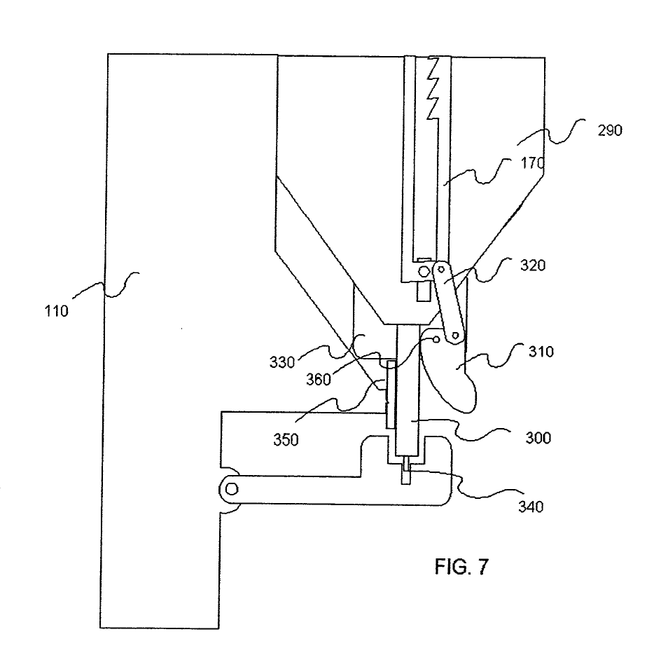

An embodiment of the dispenser suitable for dispensing medication from bulk-packaging is shown in FIG. 6. A bulk-package of medication 290 is held in dispenser 100. Roller 190 rests against plastic film 180, which ensures that roller 190 does not become entangled with the plastic or other packaging material as it collapses as medication is dispensed. Dispensing lever 310 rests against dispensing tube 300, and is connected to toothed ratchet 170 by lever 320. Dispensing lever 310 is supported by plate 330 which is attached to dispenser 100. As shown in greater detail in FIG. 7, dispensing tube 300 terminates at its lower end at nozzle 340. Supporting member 350 provides a support for dispensing tube 300 to prevent it from moving away from dispensing lever 310 when that lever is activated.

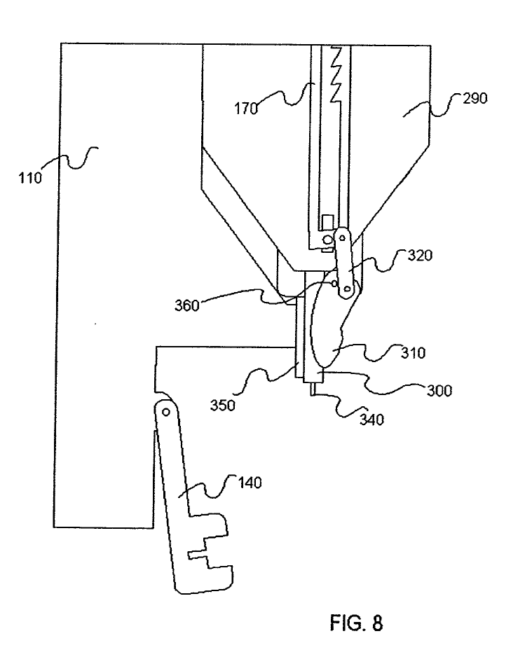

The action of dispensing medication is shown in FIG. 8, in which dispensing lever 310 has been pressed against dispensing tube 300, squeezing it and forcing it against supporting member 350. The motion of dispensing lever 310 provides a rotational motion about pivot 360, which is affixed to plate 330, causing lever 320 and toothed ratchet 170 to move downwardly. As previously explained, the downward motion of ratchet 170 causes roller 190 to move downward, maintaining pressure upon the bulk-packaged medication.

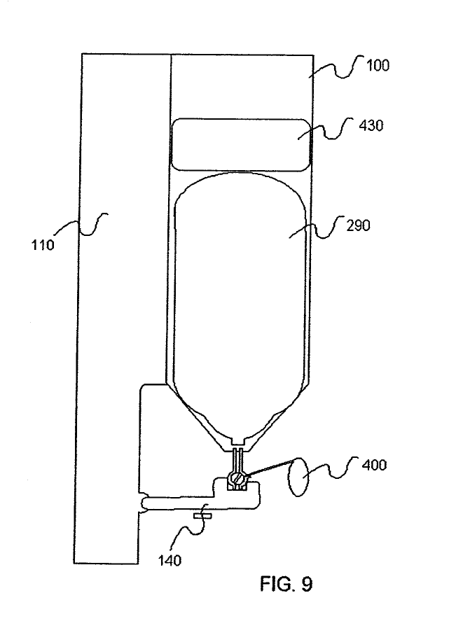

FIG. 9 illustrates another embodiment of the dispenser of this invention. In this embodiment, a constant external force is placed upon bulk-packaged medication 290 by weight 430. While the viscosity of medication 290 will determine the amount of force, if any, that will be required to push the medication out of the dispenser, it will be obvious to persons of skill in the art that other mechanisms may also be suitable for applying an external force. Among such mechanisms are included, for example, a spring, or a pneumatic or hydraulically operated piston or bladder.

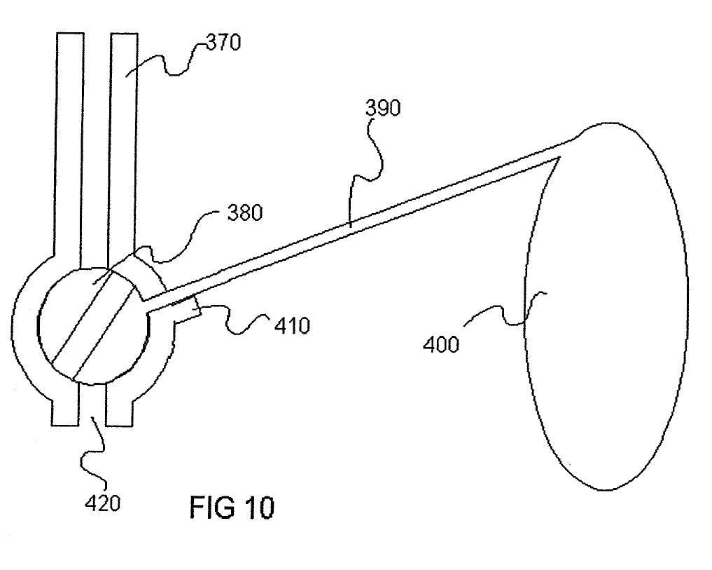

As shown in FIG. 10, the valve of this embodiment may be a ball valve that is normally closed (as shown), but that may be rotated counter-clockwise to the open position to present an unobstructed passageway for the medication to flow to outlet 420. A lever 390 normally rests against stop 410, and is maintained in that position by gravity operating upon hand lever 400, which may be made of a dense, heavy material. When hand lever 400 is raised, valve 380 presents an opening from the dispenser along passageway 370 to outlet 420. The valve will close when the manually applied force used to raise hand lever 400 is removed, allowing gravity to pull the hand lever back down. Lubrication may be provided to valve 380 by the medication flowing through the valve, although it is likely that such lubrication will not be necessary for most valves made from low friction components.

It will be understood by persons of ordinary skill in the art that various modifications and enhancements may be made to the invention as shown and described without departing from the scope and essence of the invention. For example, some types of cream tubes may be so configured that a plastic film separating the tube from the pressure mechanism is found to be unnecessary. In addition, various other mechanical configurations could be employed to apply pressure to the tube to achieve the same results as may be obtained using the configurations depicted herein. Orientations for the dispenser other than vertical would also achieve similar results. Such modifications and enhancements are deemed to be encompassed within the scope of this disclosure.

What is claimed is:

1. A topical treatment dispenser, comprising:
a sanitary housing having at least one outlet for receiving and supporting a tube containing a topical treatment;
a sanitary detachable cap for covering said outlet; and
a flow control mechanism for controlling the flow of the topical treatment through said outlet, wherein said topical treatment dispenser prevents contaminants from coming into contact with the topical treatment contained therein such that the topical treatment is dispensable in a medical environment.

2. The topical treatment dispenser according to claim 1, wherein said sanitary housing includes a flexible barrier for preventing contact between said flow control mechanism and the tube containing the topical treatment.

3. The topical treatment dispenser according to claim 2, wherein said flexible barrier is constructed of plastic.

4. The topical treatment dispenser according to claim 1, wherein the topical treatment dispenser contains a plurality of outlets, wherein each said outlet is capable of receiving and supporting the tube containing the topical treatment and said sanitary housing prevents each tube from coming into contact with any other tube.

5. The topical treatment dispenser according to claim 1, wherein the sanitary detachable cap includes an antiseptic pad for maintaining a sterile environment around said outlet.

6. The topical treatment dispenser according to claim 5, wherein said pad is imbued with an antiseptic.

7. The topical treatment dispenser according to claim 1, wherein said sanitary housing is wall-mounted.

8. The topical treatment dispenser according to claim 2, wherein said flow control mechanism includes a bladder, wherein said flexible barrier is positioned between said bladder and the tube such that said bladder exerts a force upon the tube through said flexible barrier when said bladder is inflated.

9. The topical treatment dispenser according to claim 8, wherein a fluid is used to inflate said bladder.

10. The topical treatment dispenser according to claim 9, further comprising a hand pump for manually pumping said fluid into said bladder.

11. The topical treatment dispenser according to claim 9, further comprising an electric pump for automatically pumping said fluid into said bladder.
